(19) United States
(12) Patent Application Publication
(10) Pub. No.: US 2026/0093132 A1
(43) Pub. Date: Apr. 2, 2026

(54) BACKSIDE WAVEGUIDE AND MODULATOR INTEGRATION WITH DEEP VIA

(71) Applicant: International Business Machines Corporation, Armonk, NY (US)

(72) Inventors: Ruilong Xie, Niskayuna, NY (US); Joshua Mark Rubin, Albany, NY (US); Tao Li, Slingerlands, NY (US); Qianwen Chen, Chappaqua, NY (US)

(21) Appl. No.: 18/901,135

(22) Filed: Sep. 30, 2024

(51) Int. Cl. G02F 1/025; G02F 1/035; G02F 1/061

(52) U.S. Cl. CPC G02F 1/025; G02F 1/035; G02F 1/061; G02F 2202/20

(57) ABSTRACT

Photonics integrated circuits having a backside waveguide and modulator integrated using a deep via are provided. In one aspect, a semiconductor device includes: a photonics integrated circuit having an optical waveguide and an optical modulator on a frontside of the semiconductor device, where the optical waveguide and the optical modulator have flat bottom surfaces facing a backside of the semiconductor device; and contacts including deep vias that connect a top surface of the optical modulator to the backside of the semiconductor device. Alternatively, the optical waveguide and the optical modulator can have flat top surfaces facing the frontside of the semiconductor device. A method of forming the present semiconductor devices is also provided.

### BACKGROUND

The present invention generally relates to the electrical, electronic and computer arts and, more particularly, to semiconductor devices such as photonics integrated circuits having a backside waveguide and modulator integrated using deep vias.

Photonics integrated circuits are used in a variety of different applications from fiber optic-based communication to quantum computing. As compared to electronic integrated circuits which employ electrons, photonics integrated circuits use photons (which are particles of light) to process information. As its name implies, a photonics integrated circuit contains photonic components that work together as a functioning circuit.

Components such as optical waveguides and optical modulators are important building blocks of photonics integrated circuit designs. Optical waveguides provide a means for transmitting light (information), and optical modulators modulate the light that propagates in the optical waveguides.

However, integrating these optical components into an integrated circuit process flow can present some notable challenges. For instance, a complex network of back-end-of line interconnects may be needed. Further, issues can arise around compatibility with high temperature processes.

### BRIEF SUMMARY

Principles of the invention provide photonics integrated circuits having a backside waveguide and modulator integrated using deep vias. In one aspect, a semiconductor device is provided. The semiconductor device includes: a photonics integrated circuit having an optical waveguide and an optical modulator on a frontside of the semiconductor device, where the optical waveguide and the optical modulator have flat bottom surfaces facing a backside of the semiconductor device; and contacts having deep vias that connect a top surface of the optical modulator to the backside of the semiconductor device.

In another aspect, another semiconductor device is provided. The semiconductor device includes: a photonics integrated circuit having an optical waveguide and an optical modulator on a frontside of the semiconductor device, where the optical waveguide and the optical modulator have flat top surfaces facing the frontside of the semiconductor device; a backside interconnect layer on a backside of the semiconductor device; and backside contacts that connect the backside interconnect layer to a bottom surface of the optical modulator.

In yet another aspect, a method of forming a semiconductor device is provided. The method includes: forming a photonics integrated circuit having an optical waveguide and an optical modulator on a frontside of a wafer; and forming, from the frontside of the wafer, contacts having deep vias that connect a top surface of the optical modulator to a backside of the semiconductor device.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1-26 are views of a semiconductor device having a photonics integrated circuit with a backside optical waveguide and optical modulator at different steps in a fabrication process according to one or more embodiments of the present invention, where FIG. 1 and FIG. 2 are top-down views and the remaining figures are X1, X2 or Y cross-sectional views;

FIG. 27 and FIG. 28 are X1 and X2 cross-sectional views of an alternative semiconductor device formed using backside patterning of the optical waveguide and optical modulator according to one or more embodiments of the present invention; and

FIGS. 29-32 are X1 and X2 cross-sectional views of another alternative semiconductor device formed using electro-optical materials to create a silicon-organic hybrid optical modulator according to one or more embodiments of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that in one aspect, an exemplary a semiconductor device (e.g., semiconductor device 25000) is provided. The semiconductor device includes: a photonics integrated circuit having an optical waveguide and an optical modulator on a frontside of the semiconductor device, where the optical waveguide and the optical modulator have flat bottom surfaces (e.g., flat bottom surfaces 26002 and 26004) facing a backside of the semiconductor device; and contacts (e.g., contacts 12006d and 12006e) having deep vias (e.g., deep vias 12006d′ and 12006e′) that connect a top surface of the optical modulator to the backside of the semiconductor device.

In another aspect, another semiconductor device (e.g., semiconductor device 27000, semiconductor device 31000, etc.) is provided. The semiconductor device includes: a photonics integrated circuit having an optical waveguide and an optical modulator on a frontside of the semiconductor device, where the optical waveguide and the optical modulator have flat top surfaces (e.g., flat top surfaces 28002 and 28004) facing the frontside of the semiconductor device; a backside interconnect layer (e.g., backside interconnect layer 25004′) on a backside of the semiconductor device; and backside contacts (e.g., backside contacts 25002b′ and 25002c′) that connect the backside interconnect layer to a bottom surface of the optical modulator.

In yet another aspect, a method of forming a semiconductor device (e.g., semiconductor device 25000) is provided. The method includes: forming a photonics integrated circuit having an optical waveguide and an optical modulator on a frontside of a wafer (e.g., wafer 1001); and forming, from the frontside of the wafer, contacts (e.g., contacts 12006d and 12006e) having deep vias (e.g., deep vias 12006d′ and 12006e′) that connect a top surface of the optical modulator to a backside of the semiconductor device.

Techniques as disclosed herein can provide substantial beneficial technical effects. Some embodiments may not have these potential advantages and these potential advantages are not necessarily required of all embodiments. By way of example only and without limitation, one or more embodiments of the present semiconductor devices can provide one or more of:
Easy and effective techniques for backside integration of optical waveguides and optical modulators in photonics integrated circuit designs;
Backside integration of the optical waveguides and optical modulators with fewer metal levels as compared to frontside implementations; and
Low temperature processes for the backside integration that enable silicon-organic hybrid (SOH)-based photonics which advantageously demonstrate higher speeds, and area savings.

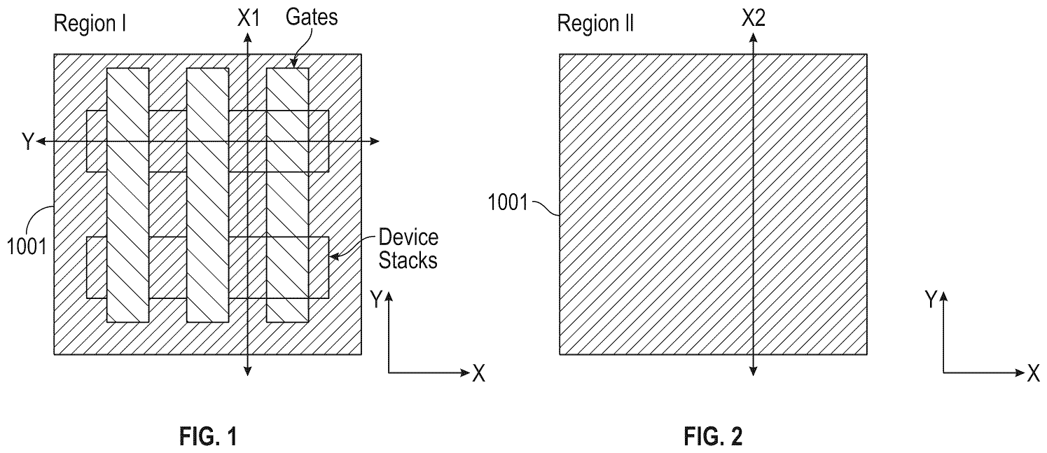

An exemplary methodology for fabricating a semiconductor device having a photonics integrated circuit with a backside optical waveguide and optical modulator in accordance with the present techniques is now described by way of reference to FIGS. 1-26. In the instant example, the semiconductor device will also have (nanosheet) field-effect transistors (FETs) co-integrated/co-fabricated with the photonics integrated circuit. For instance, as a point of reference for the cross-sectional cuts that will be presented in the figures that follow, the overall layout of the present semiconductor device is first depicted in FIG. 1 and FIG. 2 by way of top-down views. As shown in FIG. 1 and FIG. 2, the FETs and the photonics integrated circuit will be co-fabricated on different regions, i.e., Region I and Region II respectively, of the same wafer 1001. Accordingly, Region I and Region II may also be referred to herein as a ‘Logic Region’ of the wafer 1001 and a ‘Photonics Integrated Circuit Region’ of the wafer 1001, respectively. In one or more exemplary embodiments, the FETs will include multiple device stacks and multiple gates, oriented orthogonal to one another, and extending arbitrarily along an X-direction and a Y-direction, respectively. See FIG. 1.

In FIG. 1, the gates shown are representative of sacrificial gates that will be formed over the device stacks as part of a gate-last process. The term “sacrificial,” as used herein, generally refers to any material or structure that is used in one part of the process, and then later removed, in whole or in part, during fabrication of the semiconductor device. Thus, as would be apparent to one of ordinary skill in the art, with a gate-last process such sacrificial gates are formed early on in the process and serve as a placeholder for positioning other device components such as source/drain regions. Accordingly, following placement of the source/drain regions, the sacrificial gates can then be removed and replaced with the final or “replacement” gates of the device. As such, the orientation of the replacement gates will be the same as that of the sacrificial gates shown in FIG. 1. When these replacement gates are metal, they are also referred to herein as “replacement metal gates.” Advantageously, use of a gate-last process avoids exposing the replacement metal gate materials like high-κ dielectrics to potentially damaging conditions such as the high temperatures experienced during source/drain region formation.

As highlighted above, the process flow will be described by way of reference to different cross-sectional cuts through the FETs (in Region I of the wafer 1001) and the photonics integrated circuit (in Region II of the wafer 1001) of the semiconductor device. As shown in FIG. 1, the X1 cross-sectional views provided herein represent cuts through the FETs (in Region I of the wafer 1001) in the Y-direction, i.e., across the device stacks between two of the gates, and the Y cross-sectional views provided herein represent cuts through the FETs (in Region I of the wafer 1001) in the X-direction, i.e., along one of the device stacks and across the gates. As shown in FIG. 2, the X2 cross-sectional views provided herein represent cuts through the photonics integrated circuit (in Region II of the wafer 1001) in the Y-direction, i.e., through a planar area of the wafer 1001. Namely, as will become apparent from the description that follows, the (non-planar) device stacks are composed of nanosheets stacked vertically one on top of another to form active areas of the FETs in Region I of the wafer 1001. By comparison, the device stacks are removed from Region II of the wafer 1001 providing the planar area in which the photonics integrated circuit will be formed.

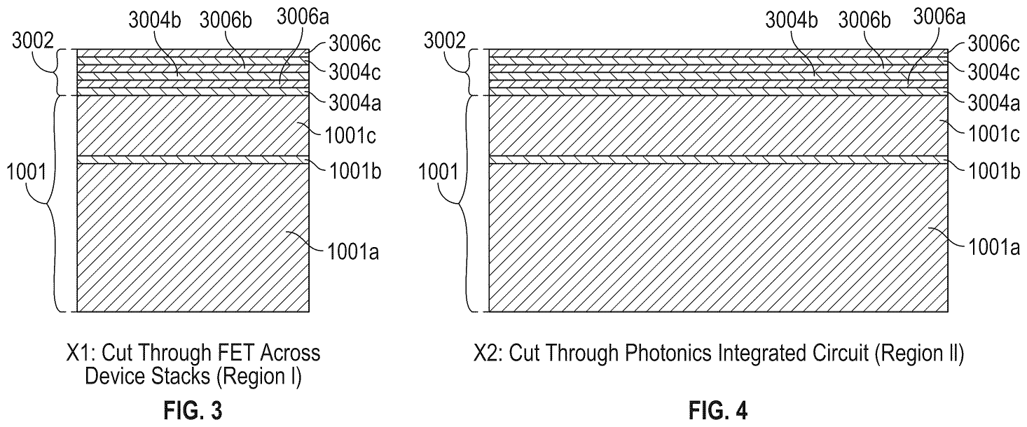

As shown in FIG. 3 (an X1 cross-sectional view) and FIG. 4 (an X2 cross-sectional view), the process begins with the formation of a stack 3002 of sacrificial and active layers on a frontside of the wafer 1001. However, as will be described in detail below, this stack 3002 of sacrificial and active layers will be selectively removed from Region II of the wafer 1001 thereby providing the planar area in which the photonics integrated circuit will be formed. The terms ‘frontside’ and ‘backside’ will be used herein to describe opposing sides of the wafer 1001. For instance, the above-described FETs and photonics integrated circuit (i.e., the optical waveguide and optical modulator) will be co-fabricated on the frontside of the wafer 1001, albeit in different regions, and middle of line contacts will be formed (see below) having deep vias that connect the FET and the photonics integrated circuit to the backside of the wafer 1001. The same orientations apply to the resulting semiconductor device, namely the frontside and backside of the wafer 1001 correspond to the frontside and backside of the semiconductor device, respectively.

In the same manner, the designations of Region I and Region II used to describe the regions of the wafer 1001 in which the FETs and the photonics integrated circuit are respectively formed also apply to the resulting semiconductor device. Namely, the semiconductor device will have a Region I corresponding to the Region I of the wafer 1001 in which it was formed containing the FETs, and a Region II corresponding to the Region II of the wafer 1001 in which it was formed containing the photonics integrated circuit.

According to an exemplary embodiment, the wafer 1001 includes a substrate 1001a, an etch stop layer 1001b disposed directly on the substrate 1001a, and a semiconductor layer 1001c disposed directly on the etch stop layer 1001b. As will be described in detail below, etch stop layer 1001b will be used during removal of the substrate 1001a from a backside of the wafer 1001. By way of example only, etch stop layer 1001b can have a thickness of from about 2 nanometers (nm) to about 50 nm. According to one exemplary embodiment, substrate 1001a is a bulk semiconductor wafer, such as a bulk silicon (Si) wafer, and etch stop layer 1001b is formed from silicon germanium (SiGe) that is epitaxially grown from the (Si) substrate 1001a. In turn, semiconductor layer 1001c (e.g., Si) can be epitaxially grown from the etch stop layer 1001b.

According to another exemplary embodiment, etch stop layer 1001b is an oxide layer. In that case, wafer 1001 can be a semiconductor-on-insulator or SOI wafer. An SOI wafer includes an SOI layer separated from an underlying substrate by a buried insulator. When the buried insulator is an oxide, it is also referred to herein as a buried oxide or BOX. In the present example, the substrate, BOX, and SOI layer correspond to the substrate 1001a, the (oxide) etch stop layer 1001b, and the semiconductor layer 1001c, respectively. As above, the SOI layer/semiconductor layer 1001c can include any suitable semiconductor material(s), such as Si.

In one exemplary embodiment, the stack 3002 of sacrificial and active layers includes alternating sacrificial and active layers oriented horizontally one on top of another on wafer 1001 (in particular, on semiconductor layer 1001c of wafer 1001). In one embodiment, the sacrificial and active layers are nanosheets. The term “nanosheet” as used herein, generally refers to a sheet or a layer having nanoscale dimensions. Further, the term “nanosheet” is meant to encompass other nanoscale structures such as nanowires. For instance, the term “nanosheet” can refer to a nanowire with a larger width, and/or the term “nanowire” can refer to a nanosheet with a smaller width, and vice versa.

For instance, as shown in FIG. 3, the stack 3002 of sacrificial and active layers can include alternating layers of sacrificial layers 3004a, b, c, etc. and active layers 3006a, b, c, etc. disposed on the wafer 1001. The present techniques involve the formation of the FETs of the semiconductor device in Region I of the wafer 1001 which, as will be described in detail below, includes removal of the sacrificial layers 3004a, b, c, etc. later on in the process to permit the formation of a gate-all-around or GAA configuration. By contrast, active layers 3006a, b, c, etc. will remain in place and serve as channels of the FETs.

It is notable that the number of sacrificial layers 3004a, b, c, etc. and active layers 3006a, b, c, etc. shown in the figures is provided merely as an example to illustrate the present techniques. For instance, embodiments are contemplated herein where more or fewer sacrificial layers 3004a, b, c, etc. and/or more or fewer active layers 3006a, b, c, etc. are present than shown. According to an exemplary embodiment, each of the sacrificial layers 3004a, b, c, etc. and active layers 3006a, b, c, etc. is deposited/formed on semiconductor layer 1001c of wafer 1001 using an epitaxial growth process. According to an exemplary embodiment, each of the sacrificial layers 3004a, b, c, etc. and active layers 3006a, b, c, etc. has a thickness of from about 6 nm to about 25 nm.

The materials employed for the sacrificial layers 3004a, b, c, etc. and active layers 3006a, b, c, etc. are such that the sacrificial layers 3004a, b, c, etc. can be removed selective to the active layers 3006a, b, c, etc. during fabrication. For instance, according to an exemplary embodiment, the sacrificial layers 3004a, b, c, etc. are each formed from silicon germanium (SiGe), while the active layers 3006a, b, c, etc. are each formed from silicon (Si). Etchants such as wet hot SC1, vapor phase hydrogen chloride (HCl), vapor phase chlorine trifluoride (ClF₃) and other reactive clean processes (RCP) are selective for etching of SiGe versus Si. This is, however, only one exemplary combination of sacrificial/active materials that may be employed in accordance with the present techniques. For instance, by way of example only, the opposite configuration can instead be implemented where the sacrificial layers 3004a, b, c, etc. are each formed from Si, and the active layers 3006a, b, c, etc. are each formed from SiGe.

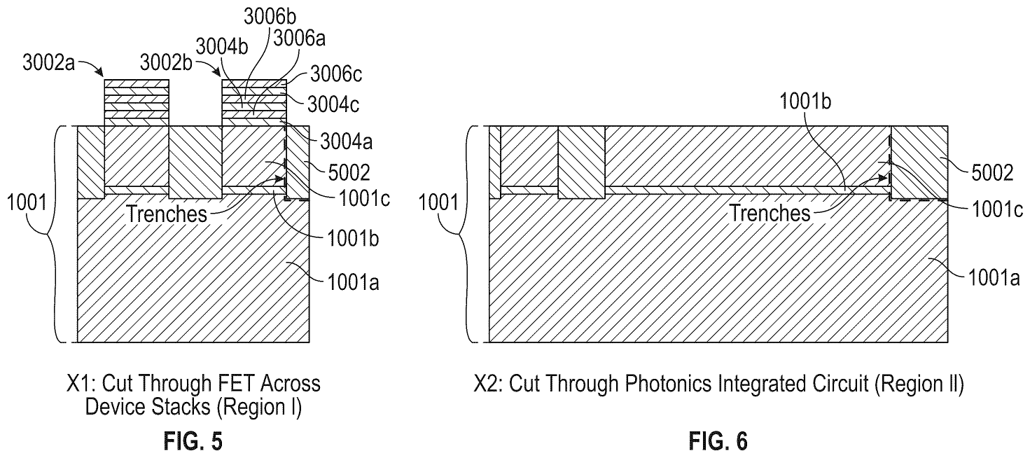

Referring to FIG. 5 (an X1 cross-sectional view) and FIG. 6 (an X2 cross-sectional view), the stack 3002 of sacrificial and active layers is then patterned into individual device stacks 3002a, b, etc. in Region I of the wafer 1001 and removed entirely from Region II of the wafer 1001, and shallow trench isolation (STI) regions 5002 are formed in the semiconductor layer 1001c both in Region I of the wafer 1001 (i.e., between the device stacks 3002a, b, etc.) and in Region II of the wafer 1001. As will become apparent from the description that follows, the device stacks 3002a, b, etc. in Region I of the wafer 1001 will correspond to a first field-effect transistor (FET1), a second FET (FET2), etc. formed therefrom on the wafer 1001 and separated by the STI regions 5002. The STI regions 5002 in Region II of the wafer 1001 will separate the optical waveguides and optical modulators formed therein.

Standard lithography and etching techniques can be employed to pattern the stack 3002 of sacrificial and active layers into the device stacks 3002a, b, etc. in Region I of the wafer 1001 and, e.g., concurrently therewith, remove the stack 3002 of sacrificial and active layers from Region II of the wafer 1001. With standard lithography and etching techniques, a lithographic stack (not shown), e.g., photoresist/anti-reflective coating/organic planarizing layer, is used to pattern a hardmask (not shown) with the footprint and location of each of the device stacks 3002a, b, etc. Suitable hardmask materials include, but are not limited to, silicon nitride (SiN), silicon oxide (SiOₓ), titanium nitride (TiN) and/or silicon oxynitride (SiON). Alternatively, the hardmask can be formed by other suitable techniques, including but not limited to, sidewall image transfer (SIT), self-aligned double patterning (SADP), self-aligned quadruple patterning (SAQP), and other self-aligned multiple patterning (SAMP).

An etch is then used to transfer the pattern from the hardmask to the stack 3002 of sacrificial and active layers to form the device stacks 3002a, b, etc. in Region I of the wafer 1001. Those portions of the stack 3002 of sacrificial and active layers not covered by the hardmask are removed, including those in Region II of the wafer 1001. Device stacks 3002a, b, etc. are representative of the ‘Device Stacks’ depicted in FIG. 1. Suitable etching processes include, but are not limited to, directional (anisotropic) etching processes such as reactive ion etching (RIE). As shown in FIG. 5 and FIG. 6, the etch used to pattern the device stacks 3002a, b, etc. extends into the semiconductor layer 1001c, forming trenches both in Region I of the wafer 1001 (i.e., between the device stacks 3002a, b, etc.) and in Region II of the wafer 1001. For clarity, a dashed outline is used in FIG. 5 and FIG. 6 to illustrate a couple of these trenches, with the understanding that a trench is present at the location of each of the STI regions 5002.

The STI regions 5002 are then formed in the trenches in Region I and Region II of the wafer 1001. In Region I of the wafer 1001, STI regions 5002 serve to isolate the device stacks 3002a, b, etc. In Region II of the wafer 1001, STI regions 5002 serve to isolate the optical waveguide and optical modulator that will be formed below. To form the STI regions 5002, a dielectric such as an oxide (which may also be generally referred to herein as a ‘shallow trench isolation (STI) oxide’) is deposited into, and filling, the trenches, followed by planarization and recess. Although not explicitly shown in the figures, a liner (e.g., a thermal oxide or silicon nitride (SiN)) may be deposited into the trenches prior to the shallow trench isolation oxide. Suitable shallow trench isolation oxides include, but are not limited to, oxide low-κ materials such as silicon oxide (SiOₓ) and/or oxide ultralow-κ interlayer dielectric (ULK-ILD) materials, e.g., having a dielectric constant κ of less than 2.7. Suitable ultralow-κ dielectric materials include, but are not limited to, porous organosilicate glass (pSiCOH). A process such as chemical vapor deposition (CVD), atomic layer deposition (ALD), or physical vapor deposition (PVD) can be employed to deposit the shallow trench isolation oxide, after which the shallow trench isolation oxide can be planarized using a process such as chemical mechanical polishing (CMP). After that, the shallow trench isolation oxide can be recessed using a dry or wet etch process to form the STI regions 5002 in Region I and Region II of the wafer 1001.

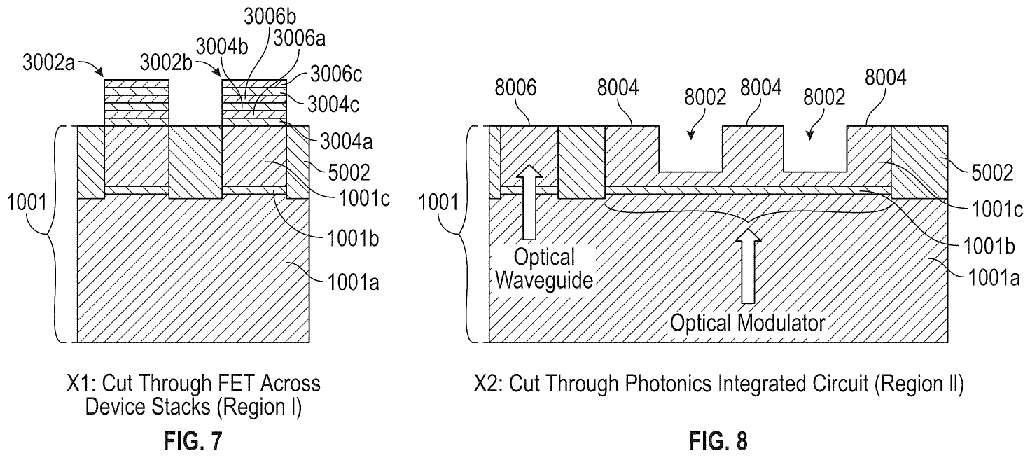

Referring to FIG. 7 (an X1 cross-sectional view) and FIG. 8 (an X2 cross-sectional view), trenches 8002 are patterned in a top surface of the semiconductor layer 1001c in Region II of the wafer 1001, thereby forming ridges 8004 in Region II of the wafer 1001. Standard lithography and etching techniques (see above) can be employed to pattern the trenches 8002/ridges 8004. Ridges 8004 will serve as the basis for forming an optical modulator. In that regard, n-type and/or p-type dopants are then implanted into the ridges 8004 for the optical modulator. Suitable n-type dopants include, but are not limited to, phosphorous (P) and/or arsenic (As). Suitable p-type dopants include, but are not limited to, boron (B). Further, as shown in FIG. 8, portion 8006 of the semiconductor layer 1001c in Region II of the wafer 1001 will serve as the basis for forming an optical waveguide. As provided above, the semiconductor layer 1001c can be formed from Si. In that case, Si-based photonics devices will be formed, i.e., an Si-based optical waveguide and an Si-based optical modulator.

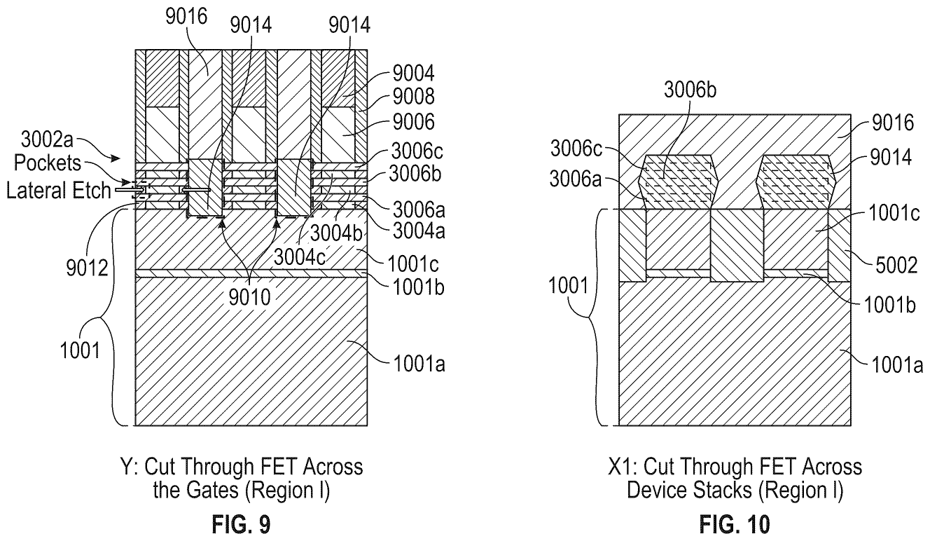

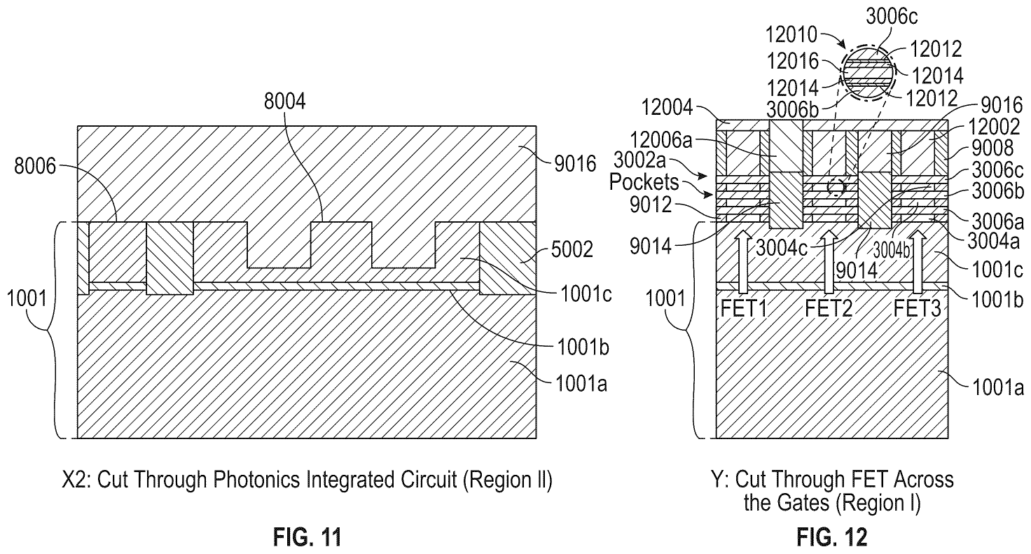

Referring to FIG. 9 (a Y cross-sectional view), FIG. 10 (an X1 cross-sectional view) and FIG. 11 (an X2 cross-sectional view), sacrificial gate hardmasks 9004 and sacrificial gates 9006 are formed on the device stacks 3002a, b, etc., dielectric spacers 9008 are formed alongside the sacrificial gate hardmasks 9004 and sacrificial gates 9006, the sacrificial gate hardmasks 9004/sacrificial gates 9006 and dielectric spacers 9008 are used as a mask to pattern trenches 9010 in the device stacks 3002a, b, etc. between the sacrificial gates 9006 which extend into the semiconductor layer 1001c of the wafer 1001, inner spacers 9012 are formed alongside the sacrificial layers 3004a, b, c, etc. within the trenches 9010, source/drain regions 9014 are formed in the trenches 9010 on opposite sides of the sacrificial gates 9006 alongside the sacrificial layers 3004a, b, c, etc. and active layers 3006a, b, c, etc., and an interlayer dielectric 9016 is deposited over the source/drain regions 9014 in Region I of the wafer 1001/within the trenches 8002 and over the ridges 8004 and portion 8006 in Region II of the wafer 1001. To form the sacrificial gates 9006, a sacrificial gate material is first blanket deposited over the device stacks 3002a, b, etc. Suitable sacrificial gate materials include, but are not limited to, poly-silicon and/or amorphous silicon. A process such as CVD, ALD or PVD can be employed to deposit the sacrificial gate material over the device stacks 3002a, b, etc. According to an exemplary embodiment, a thin (e.g., from about 1 nm to about 3 nm) layer of SiOx (not shown) is first formed on the device stacks 3002a, b, etc., followed by deposition of the poly-silicon and/or amorphous silicon.

The sacrificial gate hardmasks 9004 are then formed on the sacrificial gate material marking the footprint and location of each of the sacrificial gates 9006. Suitable hardmask materials include, but are not limited to, silicon nitride (SiN), silicon dioxide (SiO₂), titanium nitride (TiN) and/or silicon oxynitride (SiON). An etch using the sacrificial gate hardmasks 9004 is then used to pattern the sacrificial gate material into the individual sacrificial gates 9006 shown in FIG. 9. Sacrificial gates 9006 are representative of the ‘Gates’ depicted in FIG. 1.

To form the dielectric spacers 9008, a dielectric spacer material is first deposited over the device stacks 3002a, b, etc., followed by a directional (anisotropic) etching process such as reactive ion etching to pattern the dielectric spacer material into the dielectric spacers 9008 alongside the sacrificial gate hardmasks 9004 and sacrificial gates 9006. Suitable dielectric spacer materials include, but are not limited to, SiOx, silicon carbide (SiC), silicon oxycarbide (SiCO), SiN, silicoboron carbonitride (SiBCN) and/or silicon oxycarbonitride (SiOCN), which can be deposited using a process such as CVD, ALD or PVD.

A directional (anisotropic) etching process such as reactive ion etching can be employed to form the trenches 9010. To form the inner spacers 9012, a selective lateral etch is performed to first recess the sacrificial layers 3004a, b, c, etc. exposed along the sidewalls of the trenches 9010. This recess etch forms pockets along the sidewalls of the trenches 9010 that are then filled with a dielectric spacer material to form the inner spacers 9012 within the pockets. The inner spacers 9012 will serve to offset the replacement gates (see below) from the source/drain regions 9014. As provided above, the sacrificial layers 3004a, b, c, etc. can be formed from SiGe. In that case, a SiGe-selective non-directional (isotropic) etching process can be used for the recess etch. Suitable dielectric spacer materials for inner spacers 9012 include, but are not limited to, silicon nitride (SiN), SiOx, SiC and/or SiCO. A process such as CVD, ALD or PVD can be employed to deposit the dielectric spacer material into the pockets, after which excess spacer material can be removed from the trenches 9010 using an isotropic etching process such as reactive ion etching.

According to an exemplary embodiment, the source/drain regions 9014 are formed from an n-type or p-type in-situ doped (i.e., during growth) or ex-situ doped (e.g., via ion implantation) epitaxial material such as epitaxial Si, epitaxial SiGe, etc. Suitable n-type dopants include, but are not limited to, phosphorous (P) and/or arsenic (As). Suitable p-type dopants include, but are not limited to, boron (B).

Suitable interlayer dielectric 9016 materials include, but are not limited to, silicon nitride (SiN), SiOC and/or oxide low-κ materials such as SiOx and/or oxide ULK-ILD materials such as pSiCOH, which can be deposited onto the semiconductor device structure using a process such as CVD, ALD or PVD. According to an exemplary embodiment, the interlayer dielectric 9016 is a different dielectric material from the shallow trench isolation regions 5002 (e.g., interlayer dielectric 9016 can be SiN, and the shallow trench isolation regions 5002 can be SiOx).

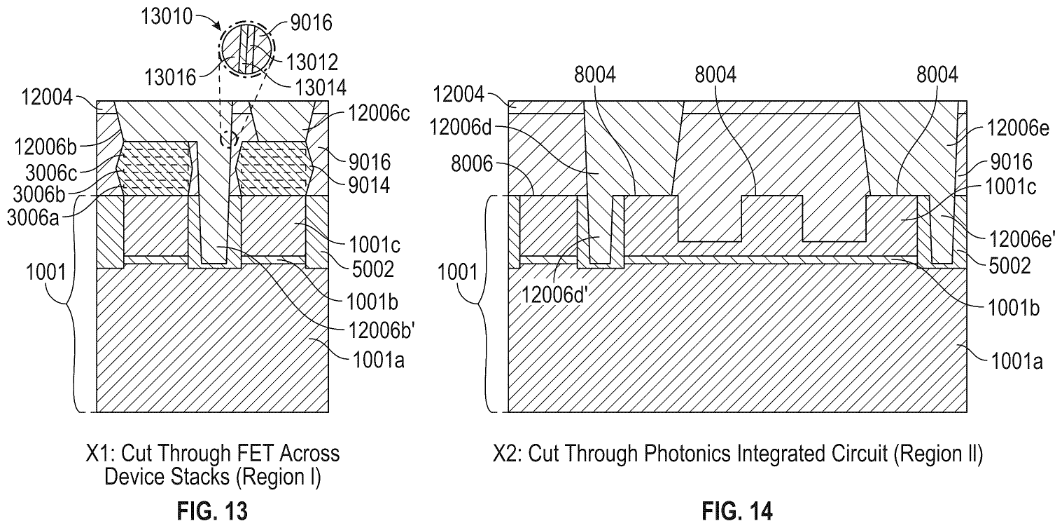

Referring to FIG. 12 (a Y cross-sectional view), FIG. 13 (an X1 cross-sectional view) and FIG. 14 (an X2 cross-sectional view), the sacrificial gate hardmasks 9004 and sacrificial gates 9006 are removed followed by the sacrificial layers 3004a, b, c, etc., replacement gates 12002 are formed surrounding each of the active layers 3006a, b, c, etc. in the device stacks 3002a, b, etc. in a gate-all-around configuration and middle of line contacts 12006a, b, c, d, e, etc. are formed in Region I and Region II of the wafer 1001 with some having deep vias to connect the FET and the photonics integrated circuit, respectively, to a backside of the wafer 1001.

A planarization process such as chemical mechanical polishing performed on the interlayer dielectric 9016 will also serve to remove the sacrificial gate hardmasks 9004 thereby exposing the underlying sacrificial gates 9006. As provided above, the sacrificial gates 9006 can be formed from a material such as poly-silicon and/or amorphous silicon. In that case, a poly-silicon or amorphous silicon-selective etching process can be employed to remove the sacrificial gates 9006. Removal of the sacrificial gates 9006 exposes the underlying device stacks 3002a, b, etc. which enables the selective removal of the sacrificial layers 3004a, b, c, etc. According to an exemplary embodiment, the sacrificial layers 3004a, b, c, etc. are formed from SiGe, while the active layers 3006a, b, c, etc. are formed from Si. In that case, etchants such as wet hot SC1, vapor phase HCl, vapor phase ClF₃ and/or other reactive clean processes can be employed to remove the sacrificial layers 3004a, b, c, etc., selective to the active layers 3006a, b, c, etc. Removal of the sacrificial layers 3004a, b, c, etc. releases the active layers 3006a, b, c, etc. from the device stacks 3002a, b, etc. These ‘released’ active layers 3006a, b, c, etc. will serve as channels of the FETs.

Replacement gates 12002 are then formed surrounding a portion of each of the active layers 3006a, b, c, etc. in a gate-all-around configuration. The term ‘gates’ may also be used herein when referring to replacement gates 12002. Looking at magnified view 12010 in FIG. 12, according to an exemplary embodiment, formation of the replacement gates 12002 begins with the deposition of a (conformal) gate dielectric 12012 onto/surrounding each of the active layers 3006a, b, c, etc. According to an exemplary embodiment, the gate dielectric 12012 is a high-κ material. The term “high-κ,” as used herein, refers to a material having a relative dielectric constant κ which is much higher than that of silicon dioxide (e.g., a dielectric constant κ=25 for hafnium oxide (HfO₂) rather than 4 for SiO₂). Suitable high-κ gate dielectrics include, but are not limited to, hafnium oxide (HfO₂) and/or lanthanum oxide (La₂O₃). A process such as CVD, ALD or PVD can be employed to deposit the gate dielectric 12012. According to an exemplary embodiment, gate dielectric 12012 has a thickness of from about 1 nanometer (nm) to about 5 nm and ranges therebetween. A reliability anneal can be performed following deposition of the gate dielectric 12012. In one exemplary embodiment, the reliability anneal is performed at a temperature of from about 500° C. to about 1200° C. and ranges therebetween, for a duration of from about 1 nanosecond to about 30 seconds and ranges therebetween. Preferably, the reliability anneal is performed in the presence of an inert gas such as, but not limited to, nitrogen.

At least one workfunction-setting metal 12014 is then deposited over the gate dielectric 12012. Suitable n-type workfunction-setting metals include, but are not limited to, titanium nitride (TiN), tantalum nitride (TaN) and/or aluminum (Al)-containing alloys such as titanium aluminide (TiAl), titanium aluminum nitride (TiAlN), titanium aluminum carbide (TiAlC), tantalum aluminide (TaAl), tantalum aluminum nitride (TaAlN), and/or tantalum aluminum carbide (TaAlC). Suitable p-type workfunction-setting metals include, but are not limited to, TiN, TaN, and/or tungsten (W). TiN and TaN are relatively thick (e.g., greater than about 2 nm) when used as p-type workfunction-setting metals. However, very thin TiN or TaN layers (e.g., less than about 2 nm) may also be used beneath Al-containing alloys in n-type workfunction-setting stacks to improve electrical properties such as gate leakage currents. Thus, there is some overlap in the exemplary n-and p-type workfunction-setting metals given above. A process such as CVD, ALD or PVD can be employed to deposit the workfunction-setting metal(s) 12014, after which the metal overburden can be removed using a process such as chemical mechanical polishing.

Optionally, a (low-resistance) fill metal 12016 can be deposited over the workfunction-setting metal(s) 12014 so as to fill in any remaining spaces in the replacement gates 12002. Suitable low-resistance fill metals 12016 include, but are not limited to, W, cobalt (Co), ruthenium (Ru) and/or Al which can be deposited using a process or combination of processes including, but not limited to, CVD, ALD, PVD, sputtering, plating, evaporation, ion beam deposition, electron beam deposition, laser assisted deposition, chemical solution deposition, etc.

As shown in FIG. 12, a plurality of FETs (i.e., FET1, FET2, FET3, etc.) is now present in Region I on a frontside of the wafer 1001. Each of the FETs includes a stack of the active layers 3006a, b, c, etc., a replacement gate 12002 (or simply a ‘gate’) surrounding the active layers 3006a, b, c, etc. in a gate-all-around configuration, and the source/drain regions 9014 on opposite sides of the stack of the active layers 3006a, b, c, etc.

To form the middle of line contacts 12006a, b, c, d, e, etc., an interlayer dielectric 12004 is first deposited onto the interlayer dielectric 9016. For clarity, the terms ‘first’ and ‘second’ may also be used herein when referring to interlayer dielectric 9016 and interlayer dielectric 12004, respectively. Suitable interlayer dielectric 12004 materials include, but are not limited to, SiN, SiOC and/or oxide low-κ materials such as SiOx and/or oxide ULK-ILD materials such as pSiCOH, which can be deposited using a process such as CVD, ALD or PVD. Following deposition, the interlayer dielectric 12004 can be planarized using a process such as chemical mechanical polishing.

Standard lithography and etching techniques (see above) are then used to pattern features (e.g., trenches and/or vias) in the interlayer dielectrics 9016/12004 over the source/drain regions 9014 in Region I of the wafer 1001, and over the optical modulator in Region II of the wafer 1001, followed by metallization to form the middle of line contacts 12006a, b, c, d, e, etc.

Looking at magnified view 13010 in FIG. 13, this metallization can include first depositing a silicide liner 13012 into and lining the features, depositing a metal adhesion layer 13014 onto the silicide liner 13012, and then depositing a fill metal 13016 onto the metal adhesion layer 13014. Suitable silicide liner 13012 materials include, but are not limited to, titanium (Ti), nickel (Ni) and/or nickel platinum (NiPt), which can be deposited using a process such as CVD, ALD or PVD. According to an exemplary embodiment, silicide liner 13012 has a thickness of from about 1 nm to about 5 nm. Suitable metal adhesion layer 13014 materials include, but are not limited to, TiN and/or TaN, which can be deposited onto the silicide liner 13012 using a process such as CVD, ALD or PVD. According to an exemplary embodiment, metal adhesion layer 13014 has a thickness of from about 1 nm to about 5 nm. Suitable fill metals 13016 include, but are not limited to, W, Co, Ru and/or Al, which can be deposited onto the metal adhesion layer 13014 using a process such as CVD, ALD, PVD, sputtering, plating, evaporation, ion beam deposition, electron beam deposition, laser assisted deposition, chemical solution deposition, etc. Following deposition, the overburden can be removed using a process such as chemical mechanical polishing. While magnified view 13010 is of the middle of line contact 12006b, it is to be understood that each of the middle of line contacts 12006a, b, c, d, e, etc. can have the same above-described configuration and be formed in the same manner as the middle of line contact 12006b.

As highlighted above, deep vias are employed herein to connect the FET and the photonics integrated circuit to the backside of the wafer 1001. For instance, as shown in FIG. 13, the middle of line contact 12006b has a deep via 12006b′ that connects a source/drain region 9014 of the FET on the frontside (Region I) of the wafer 1001 to the backside of the wafer 1001. Similarly, as shown in FIG. 14, the middle of line contacts 12006d and 12006e have deep vias 12006d′ and 12006e′ that connect the ridges 8004 on a top surface of the optical modulator on the frontside (Region II) of the wafer 1001 to the backside of the wafer 1001. According to an exemplary embodiment, as shown in FIG. 13, the deep via 12006b′ of the middle of line contact 12006b extends into one of the STI regions 5002 between adjacent source/drain regions 9014 of the FETs, but not so far as to reach the substrate 1001a. Similarly, as shown in FIG. 14, the deep vias 12006d′ and 12006e′ of the middle of line contacts 12006d and 12006e extend into the STI regions 5002 adjacent to the optical modulator, but not so far as to reach the substrate 1001a.

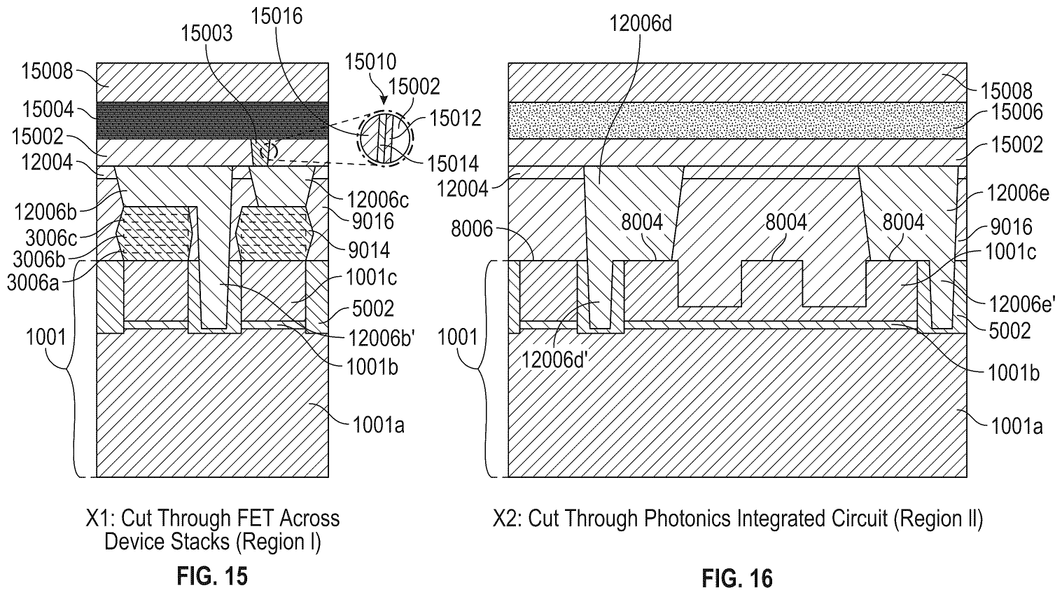

Referring to FIG. 15 (an X1 cross-sectional view) and FIG. 16 (an X2 cross-sectional view), an interlayer dielectric 15002 is deposited over the middle of line contacts 12006a, b, c, d, e, etc., a back end of line contact 15003 is formed in the interlayer dielectric 15002 that directly contacts the middle of line contact 12006c, a back end of line interconnect layer 15004 is formed over the FETs in Region I of the wafer 1001 that directly contacts the back end of line contact 15003, an optional device layer 15006 is formed over the optical waveguide and optical modulator in Region II of the wafer 1001, and the frontside of the wafer 1001 is bonded to a carrier wafer 15008 (via the back end of line interconnect layer 15004 and the device layer 15006). Namely, as will be described in detail below, the carrier wafer 15008 will enable backside processing, which includes partial removal of the wafer 1001 and the formation of backside contacts and a backside interconnect layer that are connected to the FETs and the photonics integrated circuit by way of the middle of line contacts 12006b and 12006d/12006e and their respective deep vias 12006b′ and 12006d′/12006e′.

For clarity, the term ‘third’ may also be used herein when referring to interlayer dielectric 15002 so as to distinguish it from the ‘first’ and ‘second’ interlayer dielectrics 9016 and 12004, respectively. Suitable interlayer dielectric 15002 materials include, but are not limited to, SiN, SiOC and/or oxide low-κ materials such as SiOx and/or oxide ULK-ILD materials such as pSiCOH, which can be deposited using a process such as CVD, ALD or PVD. Following deposition, the interlayer dielectric 15002 can be planarized using a process such as chemical mechanical polishing.

Standard lithography and etching techniques (see above) are then used to pattern a feature (e.g., a trench and/or a via) in the interlayer dielectric 15002 over the middle of line contact 12006c in Region I of the wafer 1001, followed by metallization to form the back end of line contact 15003. Looking at magnified view 15010 in FIG. 15, this metallization can include first depositing a silicide liner 15012 into and lining the feature, depositing a metal adhesion layer 15014 onto the silicide liner 15012, and then depositing a fill metal 15016 onto the metal adhesion layer 15014. Suitable silicide liner 15012 materials include, but are not limited to, Ti, Ni and/or NiPt, which can be deposited using a process such as CVD, ALD or PVD. According to an exemplary embodiment, silicide liner 15012 has a thickness of from about 1 nm to about 5 nm. Suitable metal adhesion layer 15014 materials include, but are not limited to, TiN and/or TaN, which can be deposited onto the silicide liner 15012 using a process such as CVD, ALD or PVD. According to an exemplary embodiment, metal adhesion layer 15014 has a thickness of from about 1 nm to about 5 nm. Suitable fill metals 15016 include, but are not limited to, W, Co, Ru and/or Al, which can be deposited onto the metal adhesion layer 15014 using a process such as CVD, ALD, PVD, sputtering, plating, evaporation, ion beam deposition, electron beam deposition, laser assisted deposition, chemical solution deposition, etc. Following deposition, the overburden can be removed using a process such as chemical mechanical polishing.

Back end of line interconnect layer 15004 generally includes interconnect structures commonly formed in the back end of line during semiconductor device fabrication. Namely, in the back end of line, individual devices such as transistors are interconnected through a series of metal layers. For instance, conductive structures like vias and metal lines can be employed to connect a device to one or more other devices, with the metal lines making lateral connections and the vias making vertical connections amongst different metallization levels. Standard metallization techniques can be employed to form the back end of line interconnect layer 15004. While the individual interconnect structures present in back end of line interconnect layer 15004 are not specifically shown in the figures, it would be apparent to one skilled in the art how such a back end of line interconnect layer 15004 is implemented for a given semiconductor device application.

Advantageously, since contact to the optical modulator will be provided from the backside of the wafer 1001, the opportunity then arises to place any additional devices and/or interconnects in Region II on the frontside of the wafer 1001 over the photonics integrated circuit (i.e., the optical waveguide and optical modulator). By way of example only, the additional devices can include, but are not limited to, resistors, capacitors such as metal-insulator-metal (MIM) capacitors and/or metal-oxide-metal (MOM) capacitors, etc. which are generally represented by (optional) device layer 15006. While the individual devices and/or interconnect structures present in device layer 15006 are not specifically shown in the figures, it would be apparent to one skilled in the art how such devices and/or interconnect structures would be implemented for a given semiconductor device application. Advantageously, the same footprint can be used from both front/backsides. Namely, referring for example to FIG. 16, if the photonics integrated circuit was instead wired to the frontside of the wafer 1001, then there would not be any space left to form the device layer 15006 (e.g., resistors, MIM capacitors and/or MOM capacitors, etc.). However, the present photonics integrated circuit is wired to the backside of the wafer 1001, thereby enabling the formation of the device layer 15006 at the frontside the wafer 1001. In that case, the photonics integrated circuit and the device layer 15006 are formed within the same footprint.

Carrier wafer 15008 is bonded to the frontside of the wafer 1001 over the back end of line interconnect layer 15004 (in Region I of the wafer 1001) and over the device layer 15006 (in Region II of the wafer 1001). Suitable carrier wafers include, but are not limited to, silicon, silicon carbide and/or glass wafers. As will be described in detail below, carrier wafer 15008 will enable the backside processing needed to connect the present backside contacts and backside interconnect layer to the FETs and photonics integrated circuit.

Processing now turns to the backside, of the wafer 1001. As would be apparent to one skilled in the art, this backside processing often involves flipping the wafer 1001 over to enable top-down fabrication, with carrier wafer 15008 serving as the bottom-most supporting substrate. With that in mind, the orientation of the present semiconductor device is not shown flipped or rotated in the figures merely for the sake of clarity, i.e., so that the orientation of the structures can be depicted in a consistent manner throughout the figures. However, this does not mean that wafer 1001 is not flipped during fabrication.

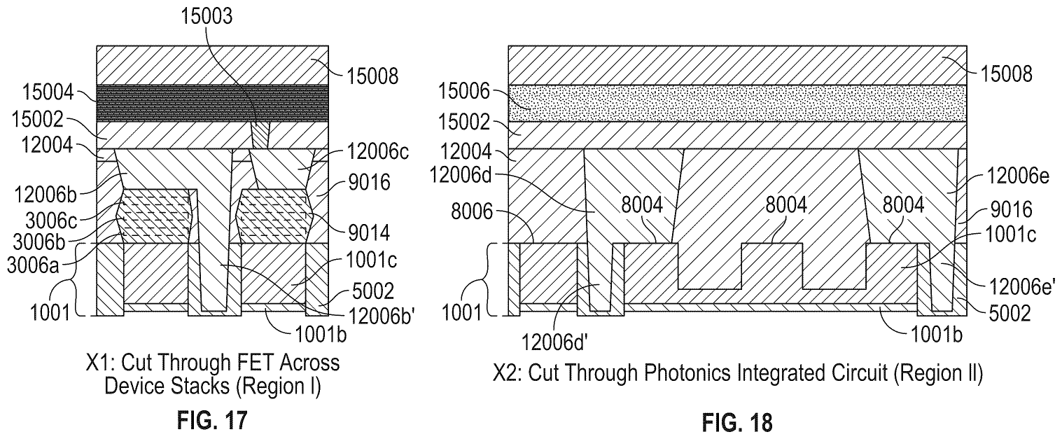

Referring to FIG. 17 (an X1 cross-sectional view) and FIG. 18 (an X2 cross-sectional view), an etch is used to remove the substrate 1001a, stopping on the etch stop layer 1001b. As provided above, etch stop layer 1001b can be formed from SiGe or an oxide material, and the substrate 1001a can be formed from Si. In that case, an Si-selective etch can be used to remove the substrate 1001a.

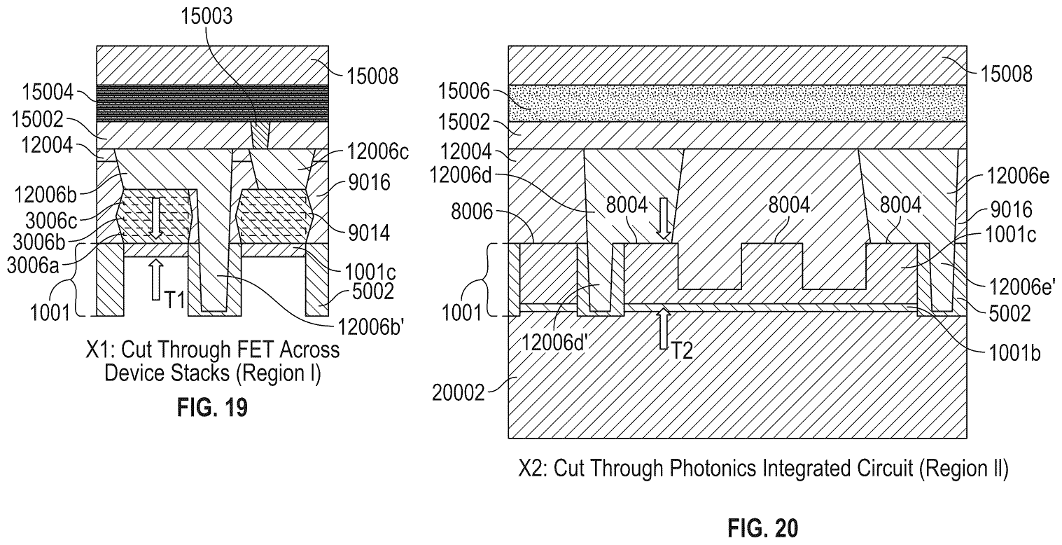

Referring to FIG. 19 (an X1 cross-sectional view) and FIG. 20 (an X2 cross-sectional view), the etch stop layer 1001b is selectively removed from Region I of the wafer 1001, and an optional partial recess of the semiconductor layer 1001c in Region I of the wafer 1001 is performed. To do so, an etch mask 20002 is first formed in Region II on the backside of the wafer 1001 of covering/protecting the etch stop layer 1001b and the semiconductor layer 1001c in Region II of the wafer 1001. Suitable etch mask 20002 materials include, but are not limited to, organic planarizing layer materials, which can be deposited using a casting process such as spray coating or spin casting.

As provided above, the etch stop layer 1001b can be formed from SiGe or an oxide material. In that case, the etch stop layer 1001b can be removed from Region I of the wafer 1001 using a SiGe or oxide-selective etch. Notably, the etch stop layer 1001b remains in Region II of the wafer 1001 beneath the etch mask 20002.

As also provided above, the semiconductor layer 1001c can be formed from Si. In that case, the semiconductor layer 1001c can (optionally) be recessed using a Si-selective etch. Notably, the semiconductor layer 1001c remains intact in Region II of the wafer 1001 beneath the etch mask 20002. As shown in FIG. 19, the semiconductor layer 1001c now has a (recessed) thickness T1 in Region I of the wafer 1001 and, as shown in FIG. 20, the semiconductor layer 1001c has a thickness T2 in Region II of the wafer 1001 (where the optical waveguide and optical modulator are present), where T1 is less than (<) T2.

The etch mask 20002 can be removed following the partial recess of the semiconductor layer 1001c. As provided above, the etch mask 20002 can be an organic planarizing layer material. In that case, the etch mask 20002 can be removed using a process such as ashing.

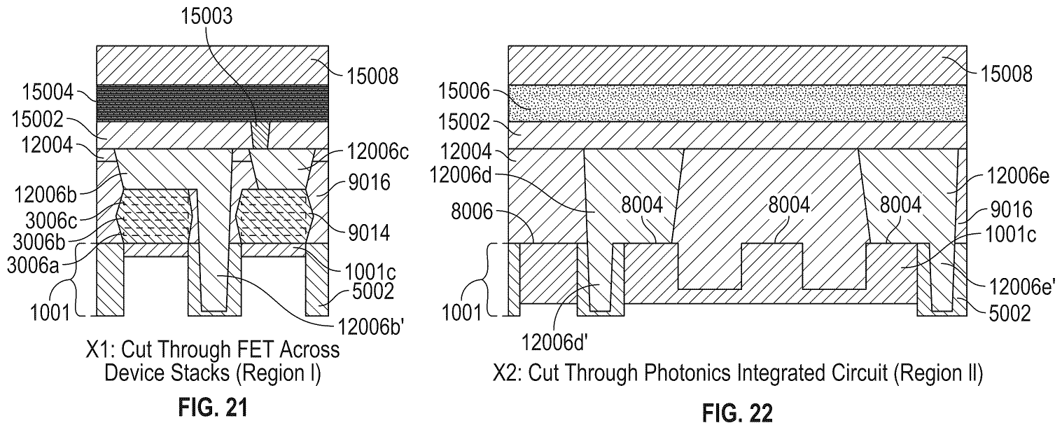

Referring to FIG. 21 (an X1 cross-sectional view) and FIG. 22 (an X2 cross-sectional view), what remains of the etch stop layer 1001b is then also removed from Region II of the wafer 1001. As above, the etch stop layer 1001b can be formed from SiGe or an oxide material. In that case, the etch stop layer 1001b can be removed from Region II of the wafer 1001 using a SiGe or oxide-selective etch. The etch stop layer 1001b is now fully removed from both Region I and Region II of the wafer 1001.

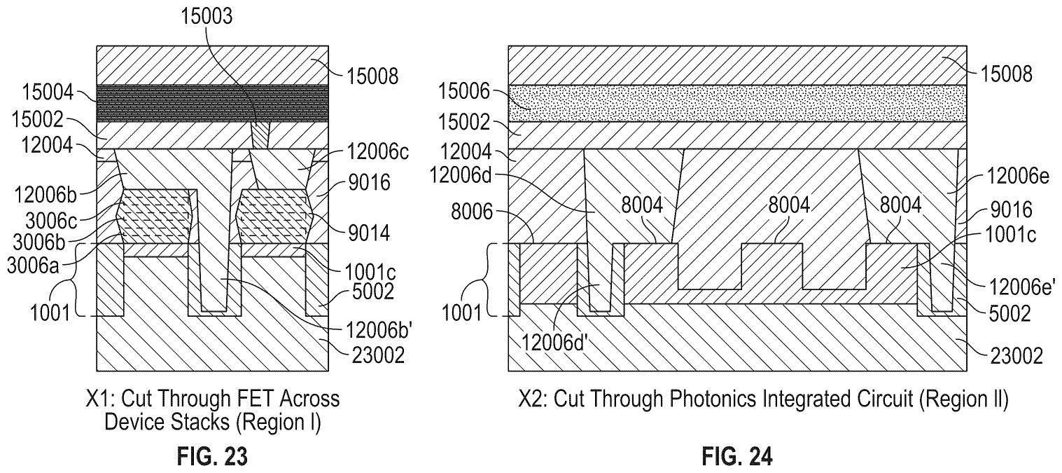

Referring to FIG. 23 (an X1 cross-sectional view) and FIG. 24 (an X2 cross-sectional view), a (backside) interlayer dielectric 23002 is then deposited onto the semiconductor layer 1001c over the STI regions 5002 on the backside of the wafer 1001. For clarity, the term ‘fourth’ may also be used herein when referring to interlayer dielectric 23002 so as to distinguish it from the ‘first’ interlayer dielectric 9016, the ‘second’ interlayer dielectric 12004, and the ‘third’ interlayer dielectric 15002. Suitable interlayer dielectric 23002 materials include, but are not limited to, SiN, SiOC and/or oxide low-κ materials such as SiOx and/or oxide ULK-ILD materials such as pSiCOH, which can be deposited using a process such as CVD, ALD or PVD. Following deposition, the interlayer dielectric 23002 can be planarized using a process such as chemical mechanical polishing.

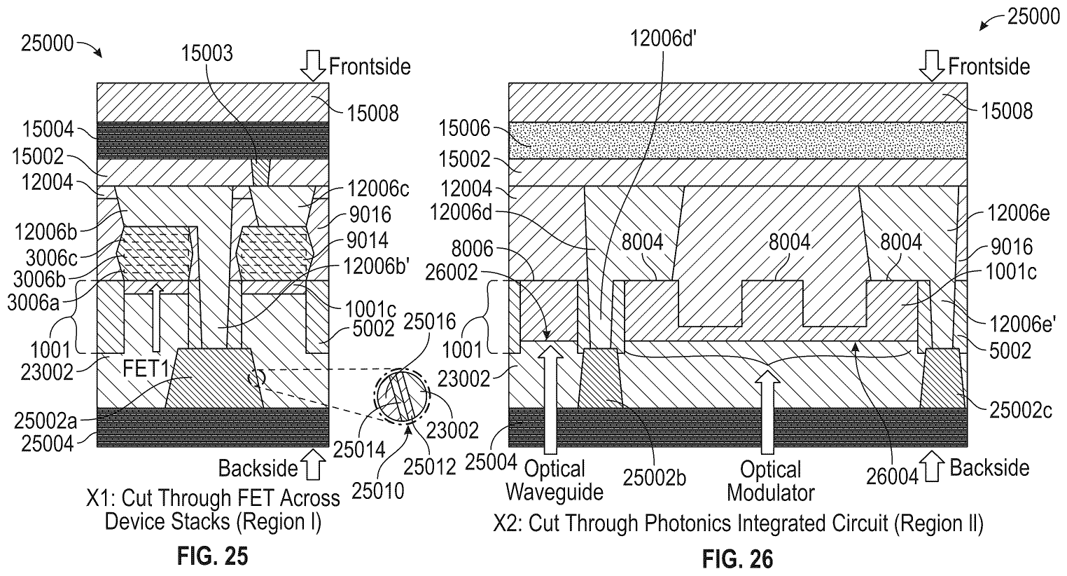

Referring to FIG. 25 (an X1 cross-sectional view) and FIG. 26 (an X2 cross-sectional view), backside contacts 25002a, b, c, etc. are formed in the interlayer dielectric 23002 from the backside of the wafer 1001 that directly contact the deep vias 12006b′, 12006d′ and 12006e′, and a backside interconnect layer 25004 is formed on the interlayer dielectric 23002 that directly contacts the backside contacts 25002a, b, c, etc. Thus, the backside contacts 25002a, b, c, etc. connect the backside interconnect layer 25004 to the FETs and the optical modulator of the photonics integrated circuit. Namely, as shown in FIG. 25, the deep via 12006b′ of the middle of line contact 12006b connects the backside interconnect layer 25004 via the backside contact 25002a to a source/drain region 9014 of a FET in Region I of the wafer 1001. As shown in FIG. 26, the deep vias 12006d′/12006e′ of the middle of line contacts 12006d/12006e connect the backside interconnect layer 25004 via the backside contacts 25002b/25002c to the top surface of the optical modulator in Region II of the wafer 1001. A completed semiconductor device 25000 is thus shown in FIG. 25 and FIG. 26.

Standard lithography and etching techniques (see above) can used to pattern features (e.g., trenches and/or vias) in the interlayer dielectric 23002 aligned with the deep vias 12006b′, 12006d′ and 12006e′, followed by metallization to form the backside contacts 25002a, 25002b and 25002c. Looking at magnified view 25010 in FIG. 25, this metallization can include first depositing a silicide liner 25012 into and lining the features, depositing a metal adhesion layer 25014 onto the silicide liner 25012, and then depositing a fill metal 25016 onto the metal adhesion layer 25014. Suitable silicide liner 25012 materials include, but are not limited to, Ti, Ni and/or NiPt, which can be deposited using a process such as CVD, ALD or PVD. According to an exemplary embodiment, silicide liner 25012 has a thickness of from about 1 nm to about 5 nm. Suitable metal adhesion layer 25014 materials include, but are not limited to, TiN and/or TaN, which can be deposited onto the silicide liner 25012 using a process such as CVD, ALD or PVD. According to an exemplary embodiment, metal adhesion layer 25014 has a thickness of from about 1 nm to about 5 nm. Suitable fill metals 25016 include, but are not limited to, W, Co, Ru and/or Al, which can be deposited onto the metal adhesion layer 25014 using a process such as CVD, ALD, PVD, sputtering, plating, evaporation, ion beam deposition, electron beam deposition, laser assisted deposition, chemical solution deposition, etc. Following deposition, the overburden can be removed using a process such as chemical mechanical polishing.

The backside interconnect layer 25004 generally includes backside interconnect structures such as conductive vias and metal lines commonly formed to interconnect the various devices, with the metal lines making lateral connections and the vias making vertical connections amongst different metallization levels. Standard metallization techniques can be employed to form the backside interconnect layer 25004. While the individual interconnect structures present in the backside interconnect layer 25004 are not specifically shown in the figures, it would be apparent to one skilled in the art how such a backside interconnect layer 25004 is implemented for a given semiconductor device application.

Based on the above-described fabrication process, the photonics integrated circuit, i.e., the optical waveguide and optical modulator, are co-formed in the semiconductor layer 1001c. Thus, another notable feature of the present semiconductor device design is that the optical waveguide and optical modulator, have flat bottom surfaces 26002 and 26004 facing the backside of the wafer 1001. See FIG. 26. In this example in particular, the flat bottom surface 26004 extends along the entire bottommost side of the optical modulator.

As highlighted above, the frontside and backside orientations of the wafer 1001 referred to herein correspond to the frontside and backside of the resulting semiconductor device. For instance, using the FETs and photonics integrated circuit as a point of reference, those structures such as the back end of line interconnect layer 15004/device layer 15006 and carrier wafer 15008 are on the frontside of the semiconductor device structure. Conversely, those structures such as the backside contacts 25002a, b, c, etc. and the backside interconnect layer 25004 are on the backside of the semiconductor device structure.

In an alternative embodiment, backside patterning of the photonics integrated circuit is employed such that the optical waveguide and optical modulator have flat top surfaces facing the frontside of the wafer 1001. Namely, in the previous example, the trenches 8002 were patterned in the semiconductor layer 1001c in Region II from the frontside of the wafer 1001 thereby forming the ridges 8004 on the frontside of the semiconductor layer 1001c, and leaving a flat bottom surface of the semiconductor layer 1001c facing the backside of the wafer 1001. See, e.g., FIG. 8, described above. By contrast, in this alternative embodiment, the patterning of the semiconductor layer 1001c is performed later on in the process from the backside of the wafer 1001, such as after the etch stop layer 1001b is removed from the Region II of the wafer 1001 as described in conjunction with the description of FIG. 22 above. Doing so advantageously enables direct wiring of the backside interconnect layer to the optical modulator in Region II by way of the backside contacts, rather than using deep vias. After which, the remainder of the process for Region II of the wafer 1001 is the same as in the previous example. This alternative process flow impacts only the few steps performed for forming the optical waveguide and optical modulator in the Region II of wafer 1001. Namely, Region I of the wafer 1001 is processed the same as in the previous example. As such, like structures are numbered alike in the figures.

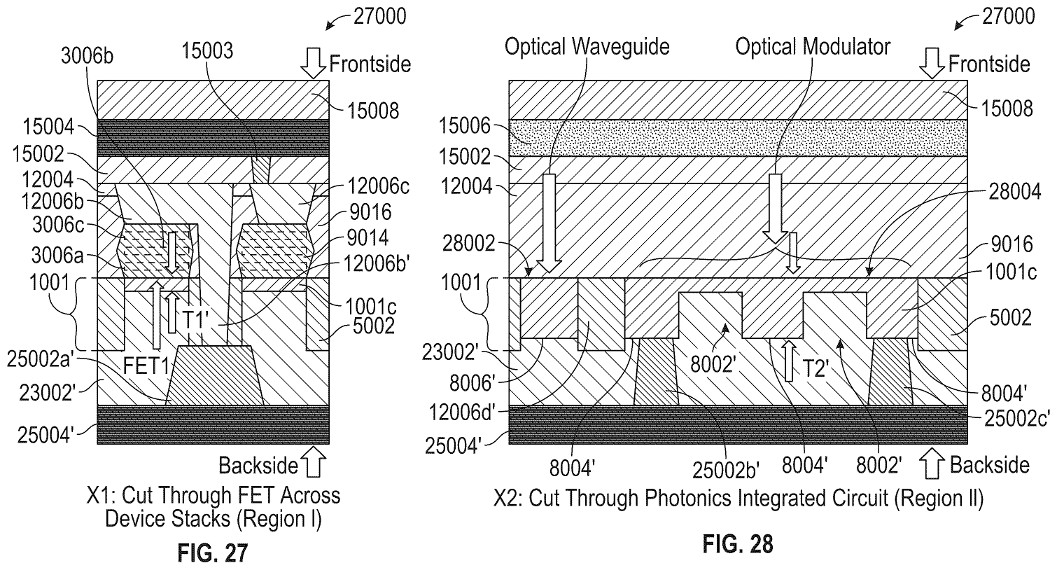

Namely, referring to Referring to FIG. 27 (an X1 cross-sectional view) and FIG. 28 (an X2 cross-sectional view), following removal of the etch stop layer 1001b from the Region II of the wafer 1001 as per FIG. 22 above, trenches 8002′ are patterned using the above-described techniques but this time in a bottom surface of the semiconductor layer 1001c in Region II of the wafer 1001, thereby forming ridges 8004′ in Region II of the wafer 1001. N-type (P and/or As) and/or p-type (e.g., B) dopants are then implanted into the ridges 8004′ for the optical modulator. A portion 8006′ of the semiconductor layer 1001c in Region II of the wafer 1001 forms the optical waveguide. As provided above, the semiconductor layer 1001c can be formed from Si. In that case, Si-based photonics devices will be formed, i.e., an Si-based optical waveguide and an Si-based optical modulator.

Backside processing of the wafer 1001 then proceeds in the same manner as described above. For instance, a (backside) interlayer dielectric 23002′ is deposited onto the semiconductor layer 1001c including within the trenches 8002′ and over the ridges 8004′ and portion 8006′ in Region II of the wafer 1001. For clarity, the term ‘fourth’ may also be used herein when referring to interlayer dielectric 23002′ so as to distinguish it from the ‘first’ interlayer dielectric 9016, the ‘second’ interlayer dielectric 12004, and the ‘third’ interlayer dielectric 15002. Suitable interlayer dielectric 23002′ materials include, but are not limited to, SiN, SiOC and/or oxide low-κ materials such as SiOx and/or oxide ULK-ILD materials such as pSiCOH, which can be deposited using a process such as CVD, ALD or PVD. Following deposition, the interlayer dielectric 23002′ can be planarized using a process such as chemical mechanical polishing.

In the same manner as above, backside contacts 25002a′, b′, c′, etc. are formed in the interlayer dielectric 23002′ from the backside of the wafer 1001 but which in this case directly contact deep via 12006b′ (in Region I of the wafer 1001) and ridges 8004′ (in Region II of the wafer 1001), and a backside interconnect layer 25004′ is formed on the interlayer dielectric 23002′ that directly contacts the backside contacts 25002a′, b′, c′, etc. Thus, the backside contacts 25002a′, b′, c′, etc. connect the backside interconnect layer 25004′ to the FETs and the optical modulator of the photonics integrated circuit. Namely, as shown in FIG. 27, the deep via 12006b′ of the middle of line contact 12006b connects the backside interconnect layer 25004′ via the backside contact 25002a′ to a source/drain region 9014 of a FET in Region I of the wafer 1001. As shown in FIG. 28, the backside contacts 25002b′/25002c′ directly connect the backside interconnect layer 25004′ to the bottom surface of the optical modulator in Region II of the wafer 1001. A completed semiconductor device 27000 is thus shown in FIG. 27 and FIG. 28.

As above, the backside interconnect layer 25004′ generally includes backside interconnect structures such as conductive vias and metal lines commonly formed to interconnect the various devices, with the metal lines making lateral connections and the vias making vertical connections amongst different metallization levels. Standard metallization techniques can be employed to form the backside interconnect layer 25004′. While the individual interconnect structures present in the backside interconnect layer 25004′ are not specifically shown in the figures, it would be apparent to one skilled in the art how such a backside interconnect layer 25004′ is implemented for a given semiconductor device application.

Based on the above-described fabrication process, the optical waveguide and optical modulator, have flat bottom surfaces 28002 and 28004 facing the frontside of the wafer 1001. See FIG. 28. In this example in particular, the flat bottom surface 28004 extends along the entire topmost side of the optical modulator. Further, as shown in FIG. 27, the semiconductor layer 1001c has a (recessed) thickness T1′ in Region I of the wafer 1001 and, as shown in FIG. 28, the semiconductor layer 1001c has a thickness T2′ in Region II of the wafer 1001 (where the optical waveguide and optical modulator are present), where T1′<T2′.

As highlighted above, the backside integration used in the present techniques advantageously enables the use of silicon-organic hybrid (SOH)-based photonics that demonstrate higher speeds, and area savings. Thus, in another alternative embodiment, electro-optical materials are incorporated into the photonic integrated circuit fabrication to create an SOH optical modulator. The use of electro-optical materials in the present semiconductor device design is only possible because the electro-optical materials are integrated into the backside of the wafer 1001 at a point in the process where they will not be exposed to any high temperatures (e.g., greater than 600° C.), which could be after formation of the backside interconnect layer 25004′.

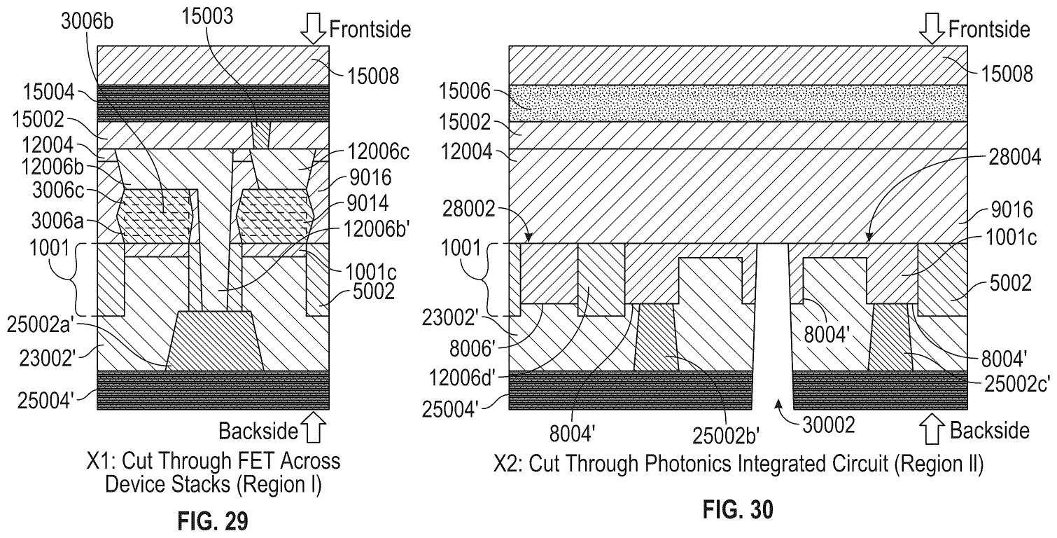

Thus, for example, following from the semiconductor device structure described in conjunction with the description of FIG. 27 and FIG. 28 above, as shown in FIG. 29 (an X1 cross-sectional view) and FIG. 30 (an X2 cross-sectional view) where like structures are numbered alike, a trench 30002 is patterned in Region II from the backside of the wafer 1001 that extends through the backside interconnect layer 25004′, the interlayer dielectric 23002′ and a middle one of the ridges 8004′ in the optical modulator. Standard lithography and etching techniques (see above) can be employed to pattern the trench 30002.

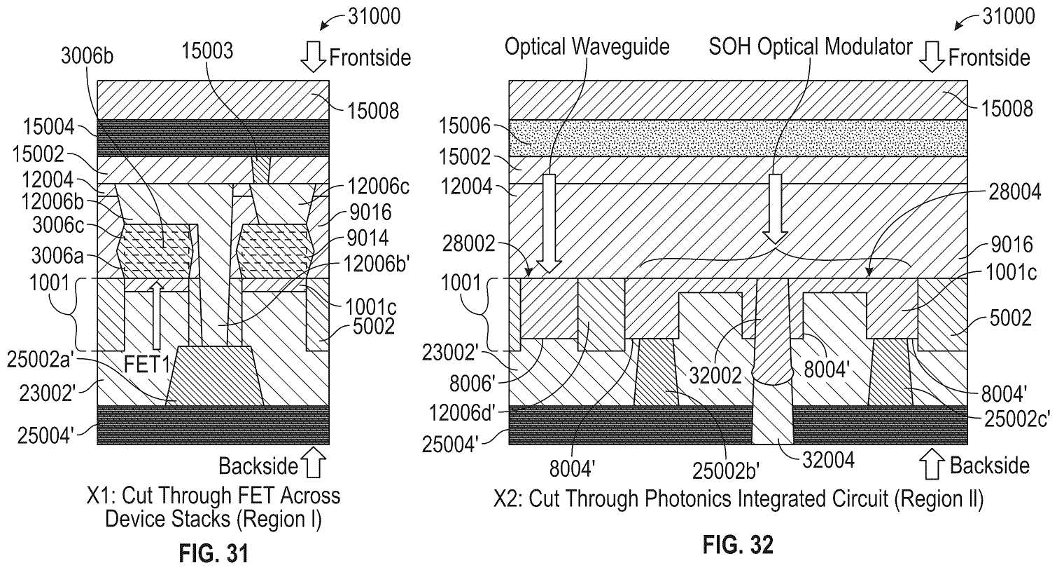

Referring to FIG. 31 (an X1 cross-sectional view) and FIG. 32 (an X2 cross-sectional view), an electro-optical material 32002 is deposited into the trench 30002, followed by an interlayer dielectric 32004. A completed semiconductor device 31000 is thus shown in FIG. 31 and FIG. 32 having an SOH optical modulator. According to an exemplary embodiment, the electro-optical material 32002 is an organic electro-optical material. Typically, organic electro-optical materials cannot withstand high temperatures (e.g., greater than 200° C.). Advantageously, with the present techniques, such organic electro-optical materials are processed last in order to avoid any subsequent high temp processes.

For clarity, the term ‘fifth’ may also be used herein when referring to interlayer dielectric 32004 so as to distinguish it from the ‘first’ interlayer dielectric 9016, the ‘second’ interlayer dielectric 12004, the ‘third’ interlayer dielectric 15002, and the ‘fourth’ interlayer dielectric 23002′. Suitable interlayer dielectric 32004 materials include, but are not limited to, SiN, SiOC and/or oxide low-κ materials such as SiOx and/or oxide ULK-ILD materials such as pSiCOH, which can be deposited using a process such as CVD, ALD or PVD. Following deposition, the interlayer dielectric 32004 can be planarized using a process such as chemical mechanical polishing.

Semiconductor device manufacturing includes various steps of device patterning processes. For example, the manufacturing of a semiconductor chip can start with, for example, a plurality of CAD (computer aided design) generated device patterns, which is then followed by effort to replicate these device patterns in a substrate. The replication process can involve the use of various exposing techniques and a variety of subtractive (etching) and/or additive (deposition) material processing procedures. For example, in a photolithographic process, a layer of photo-resist material can first be applied on top of a substrate, and then be exposed selectively according to a pre-determined device pattern or patterns. Portions of the photo-resist that are exposed to light or other ionizing radiation (e.g., ultraviolet, electron beams, X-rays, etc.) can experience some changes in their solubility to certain solutions. The photo-resist can then be developed in a developer solution, thereby removing the non-irradiated (in a negative resist) or irradiated (in a positive resist) portions of the resist layer, to create a photo-resist pattern or photo-mask. The photo-resist pattern or photo-mask can subsequently be copied or transferred to the substrate underneath the photo-resist pattern.

There are numerous techniques used by those skilled in the art to remove material at various stages of creating a semiconductor structure. As used herein, these processes are referred to generically as “etching”. For example, etching includes techniques of wet etching, dry etching, chemical oxide removal (COR) etching, and reactive ion etching (RIE), which are all known techniques to remove select material(s) when forming a semiconductor structure. The Standard Clean 1 (SC1) contains a strong base, typically ammonium hydroxide, and hydrogen peroxide. The SC2 contains a strong acid such as hydrochloric acid and hydrogen peroxide. The techniques and application of etching is well understood by those skilled in the art and, as such, a more detailed description of such processes is not presented herein.

Although the overall fabrication method and the structures formed thereby are novel, certain individual processing steps required to implement the method can utilize conventional semiconductor fabrication techniques and conventional semiconductor fabrication tooling. These techniques and tooling will already be familiar to one having ordinary skill in the relevant arts given the teachings herein. For example, the skilled artisan will be familiar with epitaxial growth, self-aligned contact formation, formation of high-K metal gates, and so on. The term “high-K” has a definite meaning to the skilled artisan in the context of high-K metal gate (HKMG) stacks, and is not a mere relative term. Moreover, one or more of the processing steps and tooling used to fabricate semiconductor devices are also described in a number of readily available publications, including, for example: James D. Plummer et al., Silicon VLSI Technology: Fundamentals, Practice, and Modeling 1^{st} Edition, Prentice Hall, 2001 and P. H. Holloway et al., Handbook of Compound Semiconductors: Growth, Processing, Characterization, and Devices, Cambridge University Press, 2008, which are both hereby incorporated by reference herein. It is emphasized that while some individual processing steps are set forth herein, those steps are merely illustrative, and one skilled in the art may be familiar with several equally suitable alternatives that would be applicable.

It is to be appreciated that the various layers and/or regions shown in the accompanying figures may not be drawn to scale. Furthermore, one or more semiconductor layers of a type commonly used in such integrated circuit devices may not be explicitly shown in a given figure for ease of explanation. This does not imply that the semiconductor layer(s) not explicitly shown are omitted in the actual integrated circuit device.

Those skilled in the art will appreciate that the exemplary structures discussed above can be distributed in raw form (i.e., a single wafer having multiple unpackaged chips), as bare dies, in packaged form, or incorporated as parts of intermediate products or end products.

An integrated circuit in accordance with aspects of the present inventions can be employed in essentially any application and/or electronic system. Given the teachings of the present disclosure provided herein, one of ordinary skill in the art will be able to contemplate other implementations and applications of embodiments disclosed herein.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods can occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose may be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. A semiconductor device, comprising:
a photonics integrated circuit comprising an optical waveguide and an optical modulator on a frontside of the semiconductor device, wherein the optical waveguide and the optical modulator have flat bottom surfaces facing a backside of the semiconductor device; and
contacts comprising deep vias that connect a top surface of the optical modulator to the backside of the semiconductor device.

2. The semiconductor device of claim 1, wherein the optical waveguide is a silicon-based optical waveguide and the optical modulator is a silicon-based optical modulator.

3. The semiconductor device of claim 1, further comprising:
a backside interconnect layer on the backside of the semiconductor device; and
backside contacts that connect the backside interconnect layer to the optical modulator by way of the deep vias.

4. The semiconductor device of claim 1, further comprising:
at least one field-effect transistor on the frontside of the semiconductor device in a first region (Region I) of the semiconductor device, wherein the photonics integrated circuit is present on the frontside of the semiconductor device in a second region (Region II) of the semiconductor device.

5. The semiconductor device of claim 4, further comprising:
a semiconductor layer in which the optical waveguide and the optical modulator are present, wherein the semiconductor layer has a thickness T1 in the Region I of the semiconductor device and a thickness T2 in the Region II of the semiconductor device, and wherein T1<T2.

6. The semiconductor device of claim 4, wherein the contacts further comprise other deep vias that connect the at least one field-effect transistor to the backside of the semiconductor device.

7. The semiconductor device of claim 6, further comprising:
a backside interconnect layer on the backside of the semiconductor device; and
backside contacts that connect the backside interconnect layer to the at least one field-effect transistor by way of the other deep vias.

8. A semiconductor device, comprising:
a photonics integrated circuit comprising an optical waveguide and an optical modulator on a frontside of the semiconductor device, wherein the optical waveguide and the optical modulator have flat top surfaces facing the frontside of the semiconductor device;
a backside interconnect layer on a backside of the semiconductor device; and
backside contacts that connect the backside interconnect layer to a bottom surface of the optical modulator.

9. The semiconductor device of claim 8, wherein the optical waveguide is a silicon-based optical waveguide and the optical modulator is a silicon-based optical modulator.

10. The semiconductor device of claim 8, further comprising:
at least one field-effect transistor on the frontside of the semiconductor device in a first region (Region I) of the semiconductor device, wherein the photonics integrated circuit is present on the frontside of the semiconductor device in a second region (Region II) of the semiconductor device.

11. The semiconductor device of claim 10, further comprising:
a semiconductor layer in which the optical waveguide and the optical modulator are present, wherein the semiconductor layer has a thickness T1′ in the Region I of the semiconductor device and a thickness T2′ in the Region II of the semiconductor device, and wherein T1′<T2′.

12. The semiconductor device of claim 10, further comprising:
contacts comprising deep vias that connect the at least one field-effect transistor to the backside of the semiconductor device.

13. The semiconductor device of claim 10, wherein the optical modulator further comprises:
an electro-optical material selected from the group consisting of: lithium niobate, barium titanate, lithium tantalate, potassium titanyl phosphate, β-barium borate, an organic electro-optic material, and combinations thereof.

14. The semiconductor device of claim 13, wherein the electro-optical material comprises the organic electro-optic material, and wherein the optical modulator is a silicon-organic hybrid optical modulator.

15. A method of forming a semiconductor device, the method comprising:
forming a photonics integrated circuit comprising an optical waveguide and an optical modulator on a frontside of a wafer; and
forming, from the frontside of the wafer, contacts comprising deep vias that connect a top surface of the optical modulator to a backside of the semiconductor device.

16. The method of claim 15, wherein the optical waveguide is a silicon-based optical waveguide and the optical modulator is a silicon-based optical modulator.

17. The method of claim 15, further comprising:
forming a backside interconnect layer on the backside of the wafer; and
forming backside contacts, from the backside of the wafer, that connect the backside interconnect layer to the optical modulator by way of the deep vias.

18. The method of claim 15, further comprising:
forming at least one field-effect transistor on the frontside of the semiconductor device in a first region (Region I) of the semiconductor device, wherein the photonics integrated circuit is formed on the frontside of the semiconductor device in a second region (Region II) of the semiconductor device.

19. The method of claim 18, wherein the contacts formed from the frontside of the wafer further comprise other deep vias that connect the at least one field-effect transistor to the backside of the semiconductor device.

20. The semiconductor device of claim 19, further comprising:
forming a backside interconnect layer on the backside of the semiconductor device; and
forming backside contacts, from the backside of the wafer, that connect the backside interconnect layer to the at least one field-effect transistor by way of the other deep vias.
